(19) United States
(12) Patent Application Publication
(10) Pub. No.: US 2021/0268479 A9
(43) Pub. Date: Sep. 2, 2021

(54) TITANIUM DIOXIDE SOL, METHOD FOR PREPARATION THEREOF AND PRODUCTS OBTAINED THEREFROM

(71) Applicant: VENATOR GERMANY GMBH, Duisburg (DE)

(72) Inventors: RALF BECKER, Bottrop (DE); Tobias THIEDE, Herne (DE); Nicole GALBARCZYK, Krefeld (DE); Simon BONNEN, Moers (DE)

(73) Assignee: VENATOR GERMANY GMBH, Duisburg (DE)

(21) Appl. No.: 16/306,905

(22) PCT Filed: Jun. 2, 2017
(86) PCT No.: PCT/EP2017/063441

§ 371 Date: Dec. 4, 2018

(30) Foreign Application Priority Data
Jun. 6, 2016 (DE) 10 2016 110 374.8

(51) Int. Cl. B01J 21/06; B01J 21/08; B01J 37/04; B01J 37/03; B01J 37/00; B01J 37/06; B01J 37/02; B01J 35/02; B01J 35/10; B01J 35/00; C01B 17/04

(52) U.S. Cl. CPC B01J 21/063; B01D 53/9418; B01J 21/08; B01J 37/04; B01J 37/036; B01J 37/009; B01J 37/06; B01J 37/0236; B01J 35/026; B01J 35/1019; B01J 35/1061; B01J 35/1038; B01J 35/006; B01J 35/004; C01B 17/0434; B01J 21/066

(57) ABSTRACT

A method for preparing a sol comprising TiO₂ and ZrO₂ and/or hydrated forms of TiO₂ and ZrO₂. The method includes mixing a material which includes metatitanic acid in an aqueous phase with a zirconyl compound or with a mixture of several zirconyl compounds. The material is provided either as a suspension or as a filter cake from the sulfate method. The material includes a H₂SO₄ content of 3 to 15 wt.-% relative to a quantity of TiO₂ in the material. The zirconyl compound or the mixture of several zirconyl compounds is mixed in a quantity that is sufficient to provide the sol depending on the H₂SO₄ content.

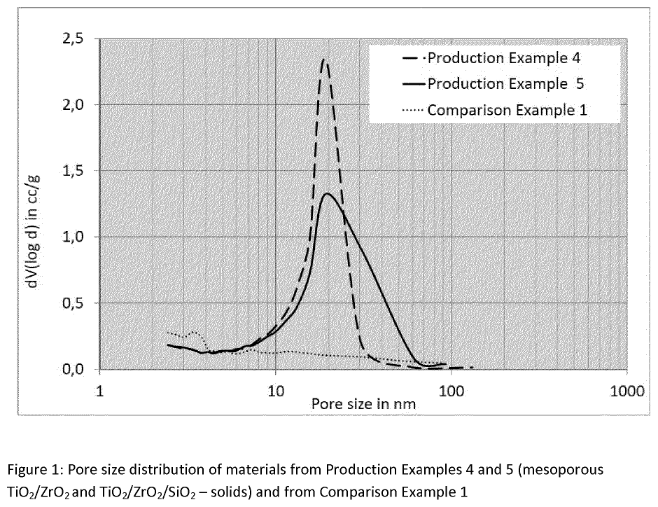

### CROSS REFERENCE TO PRIOR APPLICATIONS

This application is a U.S. National Phase application under 35 U.S.C. § 371 of International Application No. PCT/EP2017/063441, filed on Jun. 2, 2017 and which claims benefit to German Patent Application No. 10 2016 110 374.8, filed on Jun. 6, 2016. The International Application was published in English on Dec. 14, 2017 as WO 2017/211712 A1 under PCT Article 21(2).

### FIELD

The present invention relates to the preparation of a titanium dioxide-containing sol which contains a titanium compound which can, for example, be obtained when TiO₂ is prepared according to the sulfate method by hydrolysis of a solution containing titanyl sulfate and/or which has a microcrystalline anatase structure and contains a zirconium compound, and the titanium dioxide sol obtained thereby, and the use thereof.

### BACKGROUND

Titanium dioxide sols are used in a wide range of applications, including heterogeneous catalysis. Such sols are used, for example, to prepare photocatalysts or also as binders in the production of extruded catalytic bodies or coating processes. The anatase modification is preferred particularly in these two application fields because it exhibits generally better photocatalytic activity and provides a larger surface area than the rutile modification, which is actually thermodynamically more stable.

Several different methods exist to prepare anatase TiO₂ sols. Typical production processes include the hydrolysis of organic TiO₂ precursor compounds such as alcoholates or acetylactonates etc. or of TiO₂ precursor compounds which are available on an industrial scale, for example, TiOCl₂ and TiOSO₄. Besides hydrolysis, which can be carried out with or without hydrolysing nuclei, the fine-grain anatase TiO₂ can also be prepared with neutralization reactions.

The method is normally carried out in an aqueous medium, and the acids and bases used are often substances which are commonly available in industrial quantities (for example, HCl, HNO₃, H₂SO₄, organic acids, alkaline or alkaline earth hydroxides or carbonates, ammonia or organic amines). During the hydrolysis, and particularly in the case of neutralization reactions, salts or other dissociable compounds (such as H₂SO₄) are added to the solution, which must then be removed from the suspension obtained before a subsequent peptization. This is performed by filtration and washing with desalinated water, often preceded by a neutralization step (in the case of suspensions containing H₂SO₄, for example). Peptization is then performed, for example, by adding monoprotonic acids such as HCl or HNO₃ at low pH values. Many processes based on acidic sols of this kind are described for preparing neutral or basic sols. Organic acids (such as citric acid) are typically first added to the acidic sol, and the pH value is then adjusted to the desired range with suitable bases (ammonia, NaOH, KOH or organic amines).

The manufacture of anatase TiO₂ sols on an industrial scale depends not only on inexpensive raw materials, but also on simple, stable manufacturing processes. Metalorganic TiO₂ sources are not considered to be suitable raw materials because of their very high price and the difficulty associated with handling due to the release of organic compounds during hydrolysis and the consequently stricter requirements in terms of occupational safety and disposal. TiOCl₂ and TiOSO₄ may be used as starter compounds and can be obtained via the two industrial production processes (the chloride process and the sulfate process, see also Industrial Inorganic Pigments, 3rd edition, published by Gunter Buxbaum, Wiley-VCH, 2005), although they are manufactured for this purpose in special processes and separately from the main product flow.

### SUMMARY

An aspect of the present invention is to provide a method for preparing a TiO₂ containing sol that can be performed inexpensively and with reduced processing effort.

In an embodiment, the present invention provides a method for preparing a sol comprising TiO₂ and ZrO₂ and/or hydrated forms of TiO₂ and ZrO₂. The method includes mixing a material comprising metatitanic acid in an aqueous phase with a zirconyl compound or with a mixture of several zirconyl compounds. The material is provided either as a suspension or as a filter cake from the sulfate method. The material comprises a H₂SO₄ content of 3 to 15 wt.-% relative to a quantity of TiO₂ in the material. The zirconyl compound or the mixture of several zirconyl compounds is mixed in a quantity that is sufficient to provide the sol depending on the H₂SO₄ content. The method of the present invention uses starter materials that are available on an industrial scale and which are thus also inexpensive, and includes only a small number of stable and accordingly simple process steps.

### BRIEF DESCRIPTION OF THE DRAWING

The present invention is described in greater detail below on the basis of embodiments and of the drawing in which:

The sole Figure shows the pore size distribution of materials from Example 4 and Example 5 (mesoporous TiO₂/ZrO₂ and TiO₂/ZrO₂/SiO₂—solids) and from Comparitive Example 1.

### DETAILED DESCRIPTION OF THE INVENTION

The present invention thus comprises the following aspects:
A method for preparing a sol that contains titanium dioxide, zirconium dioxide and/or hydrated forms thereof, wherein a material containing metatitanic acid, which material may be a suspension or filter cake from the sulfate process and has a content of 3 to 15 wt.-% H₂SO₄ relative to the quantity of TiO₂ in the material containing metatitanic acid, is mixed in an aqueous phase with a zirconyl compound or a mixture of several zirconyl compounds, wherein the zirconyl compound is added in a quantity sufficient to convert the reaction mixture to a sol, depending on the sulfuric acid content.
The aforementioned method, wherein H₂SO₄ constitutes 4 to 12 wt.-% of the material containing metatitanic acid relative to the quantity of TiO₂ in the material containing metatitanic acid.
The aforementioned methods, wherein a zirconyl compound with an anion of a monoprotonic acid or mixtures thereof, particularly ZrOCl₂ or ZrO(NO₃)₂, is used as the zirconyl compound.
The aforementioned methods, wherein a compound containing SiO₂ or hydrated preforms thereof is also added, for example, as water glass, in a quantity from 2 to 20 wt.-% relative to the quantity of oxides after the sol is formed.
A sol which contains titanium dioxide, zirconium oxide and/or hydrated forms thereof and which may be prepared according the previously described methods.
A sol which contains titanium dioxide, zirconium oxide and/or hydrated forms thereof, having a content of 3 to 15 wt.-% sulfate relative to the TiO₂ content in the material containing metatitanic acid.
A method as described above, wherein a stabilizer is added to the sol obtained and the sol is then mixed with a base in a quantity sufficient to obtain a pH value of at least 5.
A sol which may be prepared according to the last described method.
Use of the sol in the production of catalytic bodies or in coating processes.
A method as described above, wherein the sol obtained is adjusted with a base to obtain a pH value of the mixture of between 4 and 8, particularly between 4 and 6, the precipitated particulate material containing titanium dioxide, zirconium oxide, optionally SiO₂ and/or hydrated forms thereof is filtered off, washed until a filtrate conductivity <500 μS/cm, particularly <100 μS/cm is reached, and dried to a constant mass.
A particulate TiO₂ obtainable according to the last described method.
A particulate TiO₂ having:
   A content of 3 to 40 wt.-% ZrO₂, particularly of 5 to 15 wt.-% ZrO₂, wherein hydrated forms of TiO₂ and ZrO₂ are included;
   A content of mesopores with a pore size in the range from 3 to 50 nm more than 80%, particularly more than 90% of the total pore volume of more than 0.40, particularly more than 0.50 and most particularly more than 0.60 ml/g;
   A BET of more than 150 m²/g, particularly more than 200 m²/g, and most particularly more than 250 m²/g; and
   Particularly with a microcrystalline anatase structure having crystallite sizes from 5-50 nm, wherein the wt.-% is calculated as oxides and refer to the weight of the final product.
The particulate TiO₂ as described previously, additionally having a content of 3 to 20 wt.-% SiO₂, particularly 5 to 15 wt.-% SiO₂, wherein hydrated forms of TiO₂, ZrO₂ and SiO₂ are included, wherein the wt.-% are calculated as oxides and refer to the weight of the final product.
The particulate TiO₂ as described previously, additionally containing a catalytically active metal selected from Co, Ni, Fe, W, V, Cr, Mo, Ce, Ag, Au, Pt, Pd, Ru, Rh, Cu or mixtures thereof in a quantity from 3 to 15 wt.-%, wherein the wt.-% are calculated as oxides and refer to the weight of the final product.
A use of the particulate TiO₂ as described previously as a catalyst or for the production thereof, particularly as a catalyst in heterogeneous catalysis, photocatalysis, SCR, hydrotreating, Claus, Fischer Tropsch.

The embodiments of the present invention described below may be combined with each other in any way and thereby result in other embodiments.

The following detailed description discloses embodiments according to the present invention.

Unless otherwise stated, in the context of the present application, the words “comprising” or “comprises” are used to indicate that additional optional components besides those components that are explicitly listed may be present. Use of these terms is also intended to mean that the embodiments which consist purely of the listed components, i.e., which contain no components other than those listed, are also included within the meaning of the words.

Unless stated otherwise, all percentages are percentages by weight and are relative to the weight of the solid that has been dried to constant mass at 150° C. Regarding percentage data or other data for relative quantities of a component that is defined using a generic term, such data is to be understood to relate to the total quantity of all specific variants that fall within the meaning of the generic term. If a component defined generically in an embodiment according to the present invention is also specified for a specific variant that falls within the generic term, this is to be understood to mean that no other specific variants exist that also fall within the meaning of the generic term, and consequently that the originally defined total quantity of all specific variants then relates to the quantity of the one given specific variant.

TiO(OH)₂ is obtained in the sulfate process by hydrolysis of a TiOSO₄ containing solution, also called the “black solution”. In industrial processes, the solid material obtained in this way is separated from the mother liquor by filtration and washed intensively with water. In order to remove any residual extraneous ions, particularly Fe ions, as thoroughly as possible, a called “bleaching” is carried out, which reduces the Fe³+ ions, which are poorly soluble in water, to Fe²+ ions, which are readily soluble in water. A more easily prepared compound, which is also very abundant, is the fine-grained TiO₂ containing material having general formula TiO(OH)₂ which is obtained following hydrolysis of the TiOSO₄ containing “black solution” and which is also referred to as hydrated titanium oxide, titania or metatitanic acid and may be represented by the chemical formulas TiO(OH)₂, H₂TiO₃ or TiO₂* xH₂O (wherein 0<x<1). The term “microcrystalline” in this context is to be understood to mean that the analysis of the widths of the diffraction peaks in x-ray powder diffractograms of microcrystalline TiO(OH)₂ using the Scherrer equation shows an average broadening of the crystallites of 4-10 nm.

Filtration and washing yields the same TiO(OH)₂ that is also needed for high-volume pigment production. This is active in peptizing with HNO₃ or HCl, for example, to produce an acidic sol. This titanium compound or hydrated titanium oxide can, for example, have a BET surface area greater than 150 m²/g, for example, greater than 200 m²/g, for example, greater than 250 m²/g, and consists of microcrystalline TiO₂ which can easily be obtained on an industrial scale. The maximum BET surface area of the titanium compound can, for example, be 500 m²/g. The BET surface area is determined in this context in accordance with DIN ISO 9277 using N₂ at 77 K on a sample of the hydrated titanium oxide particles which has been degassed and dried for 1 hour at 140° C. The analysis is conducted with multipoint determination (10-point determination).

The prior art has described that TiO₂ of this kind can be converted into a sol. It is thereby important to remove to the greatest extent possible the remaining sulfuric acid (approximately 8 wt.-% relative to the TiO₂). This is carried out in an additional neutralization step, which is followed by a filtration/washing step. All customary bases may be used for this neutralization, for example, aqueous solutions of NaOH, KOH, NH₃ in any concentration. It may be necessary to use NH₃, in particular when the final product must contain very small quantities of alkali. Washing is ideally carried out using desalinated or low-salt water to obtain a filter cake containing little or no salt. The amount of sulfuric acid remaining after neutralization and filtration/washing is typically less than 1 wt.-% relative to the TiO₂ solid.

The sol may then be prepared from the filter cake with low sulfuric acid content by adding, for example, HNO₃ or HCl, and optionally warming. In order to convert industrially available TiO(OH)₂ into a TiO₂-containing sol by conventional means, the following process steps with the equipment and chemicals indicated are accordingly required:

1. Neutralization (reaction vessel, base for neutralization)

2. Filtration (filtration unit)

3. Washing (desalinated water)

4. Peptisation (reaction vessel, acid for peptization)

In addition to the specifically required chemicals, the appropriate equipment must thus be provided for each individual step. This means that either loss of production capacities for other products must be taken into account or investments must be made to provide that the necessary equipment and capacities are available. It must also be borne in mind that each individual process step also takes a certain amount of time, wherein washing is in particular associated with a significant time requirement.

It was surprisingly found that a TiO₂ containing sol is able to be prepared very easily by a different route, directly from the TiO(OH)₂ suspension available for industrial purposes containing about 8 wt.-% H₂SO₄ (relative to TiO₂). A zirconyl compound such as ZrOCl₂ is added to the suspension in solid or previously dissolved form therefor. As is evidenced by a marked change in viscosity, peptization takes place within a very short time, i.e., often within a few seconds, and certainly within a few minutes after the solid form has completely dissolved or the solute is fully mixed. A non-peptized suspension is considerably more difficult to stir than a peptized suspension. PCS measurements are able to provide an indication of the size of the TiO₂ units that are formed by peptization.

If sols that have been prepared conventionally are compared with the sols according to the present invention, the differences observed in the properties of the sols are only minor if they exist at all. The required quantity of added zirconyl compound such as ZrOCl₂, ZrO(NO₃)₂, (in the following ZrOCl₂ is used for exemplary purposes) is determined by the sulfuric acid content in the TiO₂ suspension used. Besides one or more zirconyl compounds, other compounds that can be converted into zirconyl compounds under the manufacturing conditions may also be used. Examples thereof are ZrCl₄ or Zr(NO₃)₄. About half the quantity (in molar ratio) of ZrOCl₂ relative to H₂SO₄ must be added to induce peptization. Consequently, for the sulfuric acid contents of about 8 wt.-% (relative to TiO₂ calculated as oxides) that are typically present in industrial processes, ZrOCl₂ must be added in such a quantity that a theoretical ZrO₂ content of approximately 6 wt.-% (ZrO₂ content relative to the combined wt.-% of TiO₂ and ZrO₂) is obtained.

Larger quantities of ZrOCl₂ may also be added, in which case peptization takes place rapidly. If H₂SO₄ is present in smaller quantities, the amount of ZrOCl₂ added may also be reduced correspondingly. The quantity of ZrOCl₂ required may also be determined for unknown H₂SO₄ contents by observing the viscosity of the suspension. Changes in the viscosity are quickly evident, particularly in the case of highly concentrated starter suspensions. Typical TiO₂ contents in the TiO(OH)₂ suspension used in industrial processes are in the range of approximately 20-35%. It follows that the sols which are prepared by the method according to the present invention have practically identical TiO₂ contents if solid ZrOCl₂ is added. If higher TiO₂ contents are necessary, an optional dewatering step may be carried out beforehand, for example, by membrane filtration. The addition of solid ZrOCl₂ to the filter cake obtained thereby (approximately 50% residual moisture) also brings about a rapid change in viscosity and subsequently peptization.

The presence of chlorine in the form of chloride ions is undesirable in many catalytic applications. For this case, zirconyl nitrate ZrO(NO₃)₂ or other zirconyl compounds with anions of monoprotonic acids or mixtures thereof may be used advantageously without a change in the properties of the resulting sol. The required molar ratios of ZrO(NO₃)₂ to H₂SO₄ correspond to those that apply when ZrOCl₂ is used.

The method according to the present invention thus offers the important advantage of the conventional method in that the process steps of neutralization, filtration and washing are dispensed with entirely. The result of this is that overall:

i) Less process equipment must be made available;

ii) Fewer chemicals are consumed; and

iii) The time required is significantly reduced.

Any increased costs for raw materials due to the use of the Zr compound are in particular offset by the fact that no investments need to be made in new equipment. Due to the extreme simplicity of the method of the present invention, it is very easy to create very high production capacity for the sol according to the present invention. On the basis of the method according to the present invention, production capacity may accordingly almost be equated with that of the industrially available starter product (TiO(OH)₂ suspension).

Process-related differences from the conventionally prepared TiO₂ containing sol appear particularly in the following parameters:

1. H₂SO₄ content; and

2. Zr content.

Since the steps of neutralization and filtration/washing required in the conventional method are omitted in the method according to the present invention, the sulfuric acid content present in the starter suspension is still undiminished in the prepared sol. The prepared sol also contains a percentage of zirconium for process-related reasons. Since in many catalytic applications the presence of zirconium is not troublesome, and in fact is often desirable (for modifying the acid-base properties, for example), the addition of the Zr compounds has no negative effects for many applications.

The acidic Zr containing TiO₂ sol according to the present invention may be used as a starter product for a range of preparations. It may be used directly as a binder in the production of heterogeneous catalysts or as a photocatalytically active material. It may also be chemically modified or processed further. The addition of citric acid with subsequent pH adjustment via ammonia or suitable organic amines known from the prior art yields, for example, neutral or basic sols (DE 4119719 A1). It is also possible to coagulate the sol according to the present invention by shifting the pH value into the more strongly basic range. This yields a white solid which can be purified of salts in a filtration and washing step and has mesoporous properties. Further additives may be included in the course of this neutralization and washing process. A high degree of thermal stability is important for many catalytic applications. In this context, the term “thermal stability” is understood to mean a rise in the rutilization temperature of the anatase TiO₂, and reduced particle growth during thermal treatment. This particle growth is particularly evident in a reduction of the BET surface area or the increased intensity of the typical anatase diffraction peaks in the x-ray powder diffractograms. In the case of anatase TiO₂, the addition of SiO₂ is also particularly advantageous for increasing thermal stability. This may be added, for example, using sodium water glass during or after the neutralization step. Other admixtures are also conceivable, and the addition of compounds containing W may be cited, for example, in particular for SCR applications.

The product obtained after neutralization and filtration/washing, which may contain further additives as described previously, may, for example, be processed further afterwards or formed immediately as filter cake or optionally as a suspension mashed with water.

A drying step may also be carried out which yields a typically fine-grained product with a BET surface area greater than 150 m²/g, for example, greater than 200 m²/g, for example, greater than 250 m²/g. Optionally, and depending on the specific application, further thermal treatment steps may be performed at higher temperatures, for example, in a rotary furnace.

Materials with various BET surface areas may result from this option depending on the temperature selected for calcining and on the chemical composition. Particularly for applications requiring very low sulfur contents, the addition of larger quantities of SiO₂ in the range from 5-20 wt.-% relative to the total weight of the oxides may result in product properties that allow for a thermal treatment where only minimal residual quantities of sulfur remain in the end product, while the BET surface area is not significantly diminished.

The present invention will be explained in greater detail below under reference to the following examples.

### EXAMPLES

### Example 1

### TiO₂/ZrO₂ Sol

1027.4 g of a hydrated titanium oxide slurry with a sulfate content w(SO₄)=7.9%/TiO₂ and a titanium dioxide content of w(TiO₂)=29.2% was reacted with 87 g ZrOCl₂*8H₂O (10% ZrO₂ relative to TiO₂). A titanium dioxide sol was produced with a titanium dioxide content w(TiO2)=26.9%, a titanium dioxide concentration of 353 g/L, and a density of 1.312 g/cm³. PCS measurement found a particle size (average) of 46 nm with magnetic stirrer dispersion. The chloride content was 1.5%, the sulfate content was 2.0%.

### Example 2

### TiO₂/ZrO₂ Sol, Concentrated

1027.4 g of a hydrated titanium oxide slurry (MTSA, SB 2/4) with a sulfate content w(SO₄)=7.9%/TiO₂ and a titanium dioxide content of w(TiO₂)=29.2% was filtered out. A 700 g filter cake with a solid content of 47.18 wt.-% was obtained. 87 g ZrOCl₂*8H₂O (10% ZrO₂ relative to TiO₂) was then added. This yielded a thixotropic titanium dioxide sol with a titanium dioxide content w(TiO₂)=37%, a titanium dioxide concentration of 556 g/L, and a density of 1.494 g/cm³. PCS measurement found a particle size (average) of 46 nm with magnetic stirrer dispersion. The chloride content was 2.1%, the sulfate content was 2.8%.

### Example 3

### TiO₂/ZrO₂ Sol Neutral/Basic

A 56 g TiO₂/ZrO₂ sol, concentrated (from production example 2) was filled up to 200 g with partially demineralized water. A solution of 13.0 g citric acid monohydrate in 20 mL water was then added. The mixture thickens. The preparation was then neutralized with ammonia, w(NH₃)=25%. It was found that a sol again forms above a pH value of about 4, and that this sol is stable up to a pH value of 9-10.

### Variation 1

A 56 g TiO₂/ZrO₂ sol, concentrated (from Example 2) was reacted undiluted with a solution of 13.0 g citric acid monohydrate in 20 mL water and adjusted to the desired pH value (>4.5) with ammonia.

### Variation 2

13.0 g of citric acid was dissolved in a 25% ammonia solution (15.4 g for approximately pH 6). This solution was pre-filled. 56 g TiO₂/ZrO₂ sol, concentrated (from Example 2) was then added.

### Variation 3

13.0 g citric acid was dissolved in a 25% ammonia solution (15.4 g for approximately pH 6). 56 g TiO₂/ZrO₂ sol, concentrated (from Example 2) was pre-filled. The ammonium citrate solution was then added.

### Variation 4

26.9 g TiO₂/ZrO₂ sol, concentrated (from Example 2) (corresponding to 9 g TiO₂) and 1 g citric acid monohydrate (10%) were mixed with agitation, then adjusted to the desired pH value with ammonia or caustic soda.

Variation 5

23.9 g TiO₂/ZrO₂-Sol, concentrated (from Example 2) (corresponding to 8 g TiO₂) and 2 g citric acid monohydrate (20%), were adjusted to the desired pH value with ammonia or caustic soda.

For all processes according to Example 3 and Variations 1 to 5, the pH value can be raised with NH₃ even up to values up to 10 without coagulation.

### Example 4

### TiO₂/ZrO₂ (Mesoporous Solid) Recipe for 300 g End Product with 90% Titanium Dioxide and 10% Zirconium Dioxide

925 g hydrated titanium oxide slurry with a titanium dioxide content of 29.2% and a sulfate content of w(SO₄)=7.9%/TiO₂ was diluted with partially demineralized water to a titanium dioxide concentration of 200 g/L. 78.5 g ZrOCl₂*8H₂O was added and the mixture was heated to 50° C. The TiO₂ was then flocculated out by neutralization with caustic soda, w(NaOH)=50%. Neutralization to pH 5.25 was thereby carried out at 50° C.

The product was then filtered and washed until a filtrate conductivity <100 μS/cm was obtained. The filter cake was then dried at 150° C. to constant mass. The BET surface area was 326 m²/g. Total pore volume was 0.62 mL/g. Mesopore volume was 0.55 mL/g. Pore diameter was 19 nm.

### Example 5

### TiO₂/ZrO₂/SiO₂ (Mesoporous Solid) Recipe for 300 g End Product with 82% Titanium Dioxide, 10% Zirconium Dioxide and 8% SiO₂

943 g hydrated titanium oxide slurry with a titanium dioxide content of 29.2% and a sulfate content of w(SO₄)=7.9%/TiO₂ was diluted with partially demineralized water to a titanium dioxide concentration of 150 g/L. 78.5 g ZrOCl₂*8H₂O was added and the mixture was heated to 50° C. The mixture was then post-treated with 68 mL sodium silicate, w(SiO₂)=358 g/L. The sodium silicate was added with agitation to the peptized TiO₂ suspension therefor via a peristaltic pump with a displacement rate of 3 mL/min. The suspension was then neutralized to a pH value of 5.25 at 50° C. with caustic soda, w(NaOH)=50%.

The product was then filtered and washed until a filtrate conductivity <100 μS/cm was obtained. The filter cake was then dried at 150° C. to a constant mass. The BET surface area was 329 m²/g. The total pore volume was 0.75 mL/g. The mesopore volume was 0.69 mL/g. The pore diameter was 19 nm.

The conditions required for preparing peptized sols was determined and calculated using further examples, with the values being listed in Table 1.

### Comparative Example 1

Comparative Example 1 was prepared in similar manner to Example 5, except that the sodium silicate was added before the ZrOCl₂*8H₂O. The BET surface area was 302 m²/g. The total pore volume was 0.29 mL/g. The mesopore volume was 0.20 mL/g. The pore diameter was 4 nm.

TABLE 1
ZrO₂ content required depending on the
H₂SO₄ content of the starter suspension

| Wt.-% ZrO₂ | Wt.-% H₂SO₄/TiO₂ | Average | |
|---|---|---|---|
| in the End | in TiO₂ Starter | Particle Size/ | n(H₂SO₄)/ |
| Product | Suspension | PCS in nm | n(ZrO₂) |
| 0 | 3.5 | not peptized | |
| 1 | 3.5 | not peptized | 4.49 |
| 2 | 3.5 | not peptized | 2.25 |
| 3 | 3.5 | 66 | 1.50 |
| 4 | 3.5 | 47 | 1.12 |
| 5 | 3.5 | 47 | 0.90 |
| 6 | 3.5 | 44 | 0.75 |
| 1 | 7.9 | not peptized | 10.14 |
| 2 | 7.9 | not peptized | 5.07 |
| 3 | 7.9 | not peptized | 3.38 |
| 4 | 7.9 | not peptized | 2.53 |
| 5 | 7.9 | 59 | 2.03 |
| 6 | 7.9 | 56 | 1.69 |
| 7 | 7.9 | 49 | 1.45 |
| 8 | 7.9 | 45 | 1.27 |
| 9 | 7.9 | 42 | 1.13 |
| 10 | 7.9 | 42 | 1.01 |
| 20 | 7.9 | 40 | 0.51 |
| 40 | 7.9 | 39 | 0.25 |

A requirement for peptization capability is accordingly that the pH value of the starter suspension must be at least 1.0 and the necessary quantity of zirconyl compound for the quantity of sulfuric acid in weight percentages must be at least 0.45, particularly at least 0.48, calculated as the wt.-% of ZrO₂ in the end product, calculated as the sum of the oxides, to the wt.-% of H₂SO₄ relative to TiO₂ in the starter suspension. Expressed as quantity ratio, the quantity of sulfuric acid may not exceed the 2.2 fold, particularly 2.0 fold, of the quantity of the added zirconyl compound (see Table 1) in order to obtain a sol according to the present invention.

### Measurement Methods

### PCS Measurements

The basis of the method is the Brownian molecular motion of the particles. The prerequisite therefor are heavily diluted suspensions in which the particles can move freely. Small particles move faster than large particles. A laser beam passes through the sample. The light scattered on the moving particles is detected at an angle of 90° . The change in light intensity (fluctuation) is measured and a particle size distribution is calculated using Stokes' Law and Mie theory. The device used is a photon correlation spectrometer with Zetasizer Advanced Software (for example, Zetasizer 1000HSa, manufactured by Malvern) ultrasonic probe; for example VC-750, manufactured by Sonics. 10 drops are removed from the sample to be analyzed and diluted with 60 ml dilution water of nitric acid (pH 1). This suspension is stirred for 5 minutes with a magnetic stirrer. The sample batch prepared in this way is heat controlled to 25° C. and diluted with dilution water of nitric acid (if necessary) for measurement, until the counts in the Zetasizer 1000HSa device are about 200 kCps. The following measurement conditions or parameters are also used:

Measuring temperature: 25° C.

Filter (attenuator): ×16

Analysis: Multimodal

Sample Ri: 2.55 Abs: 0.05

Dispersant Ri: 1.33

Dispersant Viscosity: 0.890 cP

Determination of the Specific Surface Area (Multipoint Method) and Analysis of the Pore Structure according to the Nitrogen—Gas Sorption Method (N₂ Porosimetry)

The specific surface area and the pore structure (pore volume and pore diameter) are calculated using N₂ porosimetry with the Autosorb® 6 or 6B device manufactured by Quantachrome GmbH. The BET surface area (Brunnauer, Emmet and Teller) is determined in accordance with DIN ISO 9277, the pore distribution is measured in accordance with DIN 66134.

### Sample Preparation (N₂ Porosimetry)

The sample is weighed into the measurement cell and is predried in the baking station for 16 hours in a vacuum. It is then heated to 180° C. in about 30 minutes in a vacuum. The temperature is then maintained for one hour, still under vacuum. The sample is considered to be adequately degassed if a pressure of 20-30 millitorr is established at the degasser and the needle of the vacuum gauge remains steady for about 2 minutes after the vacuum pump has been disconnected.

### Measurement/Analysis (N₂ Porosimetry)

The entire N₂ isothermal curve is measured with 20 adsorption points and 25 desorption. The measurements were analyzed as follows:

Specific surface area (multipoint BET)

5 measurement points in the analysis range from 0.1 to 0.3 p/p0

Total pore volume analysis

Calculation of the pore volume according to the Gurvich rule

(determination from the last adsorption point)

The total pore volume is determined in accordance with DIN 66134 according to the Gurvich rule. According to the Gurvich rule, the entire pore volume of a sample is determined from the last pressure point during adsorption measurement:

p. Pressure of the sorbent

p0. Saturation steam pressure of the sorbent

Vp. Specific pore volume according to the Gurvich rule (the total pore volume at p/Po=0.99) effectively the last adsorption pressure point reached during the measurement.

Analysis of average pore diameter (hydraulic pore diameter)

For this calculation, the relationship 4Vp/A_{BET} is used, corresponding to the “Average Pore Diameter”. A_{BET} specific surface area according to ISO 9277.

### Determination of Silicon Calculated as SiO₂

Weigh-in and digestion of the material with sulfuric acid/ammonium sulfate, followed by dilution with distilled water, filtration and washing with sulfuric acid. Then, incineration of the filter and gravimetric determination of the SiO₂ content.

Determination of Titanium Calculated as TiO₂

Weigh-in and digestion of the material with sulfuric acid/ammonium sulfate, or and potassium disulfate. Reduction with Al to Ti³⁺. Titration with ammonium iron(III)sulfate. (Indicator: NH₄SCN)

### Determination of Zr Calculated as ZrO₂

The material to be examined is dissolved in hydrofluoric acid. The Zr content is then analyzed by ICP-OES.

The present invention is not limited to embodiments described herein; reference should be had to the appended claims.

What is claimed is:

1-17. (canceled)

18. A method for preparing a sol comprising TiO₂ and ZrO₂ and/or hydrated forms of TiO₂ and ZrO₂, the method comprising:
mixing a material comprising metatitanic acid in an aqueous phase with a zirconyl compound or with a mixture of several zirconyl compounds,
wherein,
the material is provided either as a suspension or as a filter cake from the sulfate method,
the material comprises a H₂SO₄ content of 3 to 15 wt.-% relative to a quantity of TiO₂ in the material, and
the zirconyl compound or the mixture of several zirconyl compounds is mixed in a quantity that is sufficient to provide the sol depending on the H₂SO₄ content.

19. The method as recited in claim 18, wherein the H₂SO₄ content is 4 to 12 wt.-% relative to the quantity of TiO₂ of in the material.

20. The method as recited in claim 18, wherein the zirconyl compound is a zirconyl compound with an anion of a monoprotonic acid or mixtures thereof.

21. The method according to claim 18, wherein the zirconyl compound is ZrOCl₂ or ZrO(NO₃)₂.

22. The method as recited in claim 18, wherein, after the sol is prepared, the method further comprises:
adding a compound comprising SiO₂ or hydrated preforms of SiO₂in a quantity of 2 to 20 wt.-% relative to a quantity of oxides.

23. The method as recited in claim 22, wherein the compound comprising SiO₂ is water glass.

24. The method as recited in claim 18, wherein, after the sol is prepared, the method further comprises:
mixing the sol with a stabilizer; and
mixing the sol comprising the stabilizer with a base so as to adjust a pH value of the sol comprising the stabilizer and the base to at least 5.

25. The method as recited in claim 18, further comprising:
mixing the sol with a base so as to adjust a pH value of the sole comprising the base between 4 and 8 so as to obtain a precipitated particulate material comprising TiO₂ and ZrO₂ and/or hydrated forms of TiO₂ and ZrO₂;
filtering off and washing the precipitated particulate material comprising TiO₂ and ZrO₂ and/or hydrated forms of TiO₂ and ZrO₂ until a filtrate conductivity <500 μS/cm is reached; and
drying the filtered and washed precipitated particulate material comprising TiO₂ and ZrO₂ and/or hydrated forms of TiO₂ and ZrO₂ to a constant mass.

26. A particulate TiO₂ obtained pursuant to the method as recited in claim 25.

27. A sol comprising TiO₂ and ZrO₂ and/or hydrated forms of TiO₂ and ZrO₂ obtainable via a method comprising:
mixing a material comprising metatitanic acid in an aqueous phase with a zirconyl compound or with a mixture of several zirconyl compounds,
wherein,
the material is provided either as a suspension or as a filter cake from the sulfate method,
the material comprises a H₂SO₄ content of 3 to 15 wt.-% relative to a quantity of TiO₂ in the material, and
the zirconyl compound or the mixture of several zirconyl compounds is mixed in a quantity that is sufficient to provide the sol depending on the H₂SO₄ content.

28. The sol as recited in claim 27, wherein the sol comprises a sulfate content of 3 to 15 wt.-% relative to the quantity of TiO₂ in the material.

29. The sol as recited in claim 27, wherein, after the sol is prepared, the method further comprises:
adding a stabilizer; and
mixing the sol comprising the stabilizer with a base so as to adjust a pH value of the sole comprising the stabilizer and base to at least 5.

30. A method of using the sol as recited in claim 29 in a production of a catalyst molded body or in a coating process, the method comprising:
providing the sol as recited in claim 29; and
using the sol in a production of a catalyst molded body or in a coating process.

31. A method of using the sol as recited in claim 27 in a production of a catalyst molded body or in a coating process, the method comprising:
providing the sol as recited in claim 27; and
using the sol in a production of a catalyst molded body or in a coating process.

32. A particulate TiO₂ comprising:
a ZrO₂ content of 3 to 40 wt.-%, wherein hydrated forms TiO₂ and ZrO₂ are included;
a content of mesopores comprising a pore size of 3-50 nm which is >80% of a total pore volume of >0.40 ml/g;
a BET >150 m²/g; and
a microcrystallinc anatasc structure comprising a crystallite size of 5-50 nm. wherein. the wt.-% is calculated as oxides based on a weight of a final product.

33. The particulate TiO₂ as recited in claim 32, further comprising:
an SiO₂ content of 3 to 20 wt.-%. wherein hydrated forms of TiO₂, ZrO₂ and SiO₂ are included,
wherein,
the wt.-% is calculated as oxides based on the weight of the final product.

34. The particulate TiO₂ as recited in claim 32, further comprising:
a catalytically active metal selected from Co, Ni, Fe, W, V, Cr, Mo, Ce, Ag, Au, Pt, Pd, Ru, Rh, Cu or mixtures thereof in a quantity of 3-15 wt.-%,
wherein,
the wt.-% is calculated as oxides based on the weight of the final product.

35. A method of using the particulate TiO₂ as recited in claim 32 as a catalyst or for preparing a catalyst, the method comprising:
providing the particulate TiO₂ as reeited in claim 32; and
using the particulate TiO₂ as a catalyst or to prepare a catalyst.

36. A method of using the particulate TiO₂ as recited in claim 32 as a catalyst in a heterogeneous catalysis method, a photocatalysis method, a SCR method, a hydrotrcating method, a Claus method, or a Fischer Tropsch method, the method comprising:
providing the particulate TiO₂ as recited in claim 32; and
using the particulate TiO₂ in a heterogeneous catalysis method, a photocatalysis method, a SCR method, a hydrotrcating method, a Claus method, or a Fischer Tropsch method.
